(19) United States
(12) Patent Application Publication
(10) Pub. No.: US 2007/0180980 A1
(43) Pub. Date: Aug. 9, 2007

(54) Method and apparatus for estimating tempo based on inter-onset interval count

(75) Inventor: Jung-Gon Kim, Busan (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/603,306

(22) Filed: Nov. 22, 2006

(30) Foreign Application Priority Data
Feb. 7, 2006 (KR) 10-2006-0011618

(51) Int. Cl. G10H 7/00

(52) U.S. Cl. 84/612

(57) ABSTRACT

An apparatus for estimating a tempo includes a peak time detection unit for detecting peak times of input audio data when an amplitude of the audio data reaches peak values; an inter-onset interval (IOI) determining unit for determining IOIs between the detected peak times; an IOI clustering unit for clustering the IOIs into a plurality of 101 clusters and for determining an average of the IOIs contained in each of the IOI clusters; a tempo estimating unit for estimating a tempo of the input audio data based on the average of the IOIs of one of the IOI clusters.

This Nonprovisional Application claims priority under 35 U.S.C. §119(a) on Patent Application No. 10-2006-0011618 filed in Korea on Feb. 7, 2006, the entire contents of which are hereby incorporated by reference.

### BACKGROUND OF THE INVENTION

1. Field of the Invention

The present invention relates to a method and apparatus for estimating a tempo based on an inter-onset interval (IOI) count, and more particularly, to a method and apparatus for estimating a tempo based on an inter-onset interval (IOI) count, wherein the tempo of input audio data is estimated based on the number of the IOIs contained in the IOI clusters.

2. Description of the Related Art

Owing to rapid development of digital signal processing technologies, a tempo estimating method for measuring the tempo of the music in real time has come to be implemented.

In a conventional tempo estimating method, the tempo of input audio data is measured based on the energy of the relevant audio data.

FIG. 1 is a block diagram of a conventional tempo estimating apparatus.

Referring to FIG. 1, the conventional tempo estimating apparatus 10 comprises a root mean square (RMS) unit 11, an event detection unit 12, a clustering unit 13, a reinforcement unit 14, and a smoothing unit 15.

The RMS unit 11 of the conventional tempo estimating apparatus 10 receives the audio data and calculates the energy values of the relevant audio data. The event detection unit 12 detects the time indexes where the energy value has a local peak value and calculates the distances between the extracted time indexes, i.e., inter-onset intervals (IOIs).

The clustering unit 13 calculates the weighting factors of the extracted IOIs using the IOIs and the corresponding energy values. That is, using the weighting factors, how much the respective extracted IOIs reflect the tempo of the received audio data can be evaluated.

Further, the clustering unit 13 calculates an optimal 101 by clustering the IOIs using the weighting factors of the respective IOIs.

The reinforcement unit 14 detects the IOIs which are an integral multiple of the optimal IOI, and estimates the tempo of the received audio data using the integral multiple of the optimal IOI.

The smoothing unit 15 outputs an arithmetic mean, using the previously estimated tempo and the currently estimated tempo, as the tempo of the input audio data.

However, since the conventional temp estimating apparatus 10 determines the weighting factors and the clustering operation of the IOIs detected based on the energy of the input audio data, the tempo estimation will be easily affected by noises with high energy.

Particularly, in a case where the audio data include the voice data of a human being, the overall amplitude of the audio data is more affected by the human voices than the sounds of a musical instrument with a uniform tempo since the energy of the human voices is generally higher than that of the musical accompaniment. Therefore, if the input audio data contain the human voices and the sounds of a variety of musical instruments, it is difficult to estimate a tempo since a regular energy pattern is hard to find in the overall input audio data.

In addition, if the number of audio data used to estimate a tempo is decreased in order to estimate the tempo in real time, there is a problem in that the tempo is determined as the tempo of the audio data by means of some peak values with high energy.

Furthermore, the IOIs that determine a tempo of music generally have a mutual relation of not only an integral multiple but also a rational number multiple such as ¼, ¾, 5/4 or the like. However, since the conventional tempo estimating apparatus 10 estimates a tempo without reflecting the correlations between IOIs with a relation of a rational number multiple other than an integral multiple, the estimated tempo may not be correct.

### SUMMARY OF THE INVENTION

Therefore, the present invention is conceived to solve the aforementioned problems. It is an object of the present invention to more accurately estimate a tempo even for audio data containing noises with high energy.

It is another object of the present invention to more accurately estimate a tempo by reflecting a relation of a rational number multiple as well as an integral multiple between the detected inter-onset intervals (IOIs) when estimating the tempo.

According to an aspect of the present invention for achieving the objects, there is provided an apparatus for estimating a tempo, comprising a peak time detection unit for detecting peak times of input audio data when an amplitude of the audio data reaches peak values; an inter-onset interval (IOI) calculation unit for calculating IOIs between the detected peak times; an IOI clustering unit for clustering the IOIs according to the respective IOIs with a predetermined range of size difference into a plurality of IOI clusters and for calculating a number of the IOIs and a mean of the IOIs contained in each of the IOI clusters; and a tempo estimating unit for determining one of the means of the IOIs in the IOI clusters as a tempo of the input audio data according to the number of the IOIs contained in each of the IOI clusters.

According to another aspect of the present invention for achieving the objects, there is provided a method of estimating a tempo, comprising detecting peak times of input audio data when an amplitude of the audio data reaches peak values; calculating inter-onset intervals (IOIs) between the detected peak times; clustering the IOIs according to the respective IOIs within a predetermined range of size difference into a plurality of IOI clusters; calculating a number the IOIs and a mean of the IOIs contained in each of the IOI clusters; and determining the one of the means of the IOIs in the IOI clusters as a tempo of the input audio data according to the number of the IOIs contained in each of the IOI clusters.

According to another aspect of the present invention for achieving the objects, there is provided an apparatus for estimating a tempo, comprising a peak time detection unit for detecting peak times of input audio data when an amplitude of the audio data reaches peak values; an inter-onset interval (IOI) determining unit for determining IOIs between the detected peak times; an IOI clustering unit for clustering the IOIs into a plurality of IOI clusters and for determining an average of the IOIs contained in each of the IOI clusters; a tempo estimating unit for estimating a tempo of the input audio data based on the average of the IOIs of one of the IOI clusters.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a block diagram of a conventional tempo estimating apparatus;

FIG. 2 is a block diagram of a tempo estimating apparatus according to an embodiment of the present invention;

FIG. 3 is a detailed block diagram of a preprocessing unit 100 of FIG. 2 according to an embodiment of the present invention;

FIG. 4 is a flowchart illustrating a method of estimating a tempo according to an embodiment of the present invention;

FIG. 5 is a flowchart illustrating a method of preprocessing audio data according to an embodiment of the present invention;

FIG. 6 is a flowchart illustrating a method of detecting peak times according to an embodiment of the present invention;

FIG. 7 is a flowchart illustrating an IO calculating method according to an embodiment of the present invention;

FIG. 8 is a flowchart illustrating an IOI clustering method according to an embodiment of the present invention;

FIG. 9 is a flowchart illustrating a method of detecting associated IOI clusters according to an embodiment of the present invention;

FIG. 10 shows a block diagram of a tempo estimating apparatus according to another embodiment of the present invention;

FIG. 11 is a flowchart illustrating a method of estimating a tempo according to another embodiment of the present invention;

FIG. 12 is a graph showing a relation between a Mel frequency and a linear frequency; and

FIG. 13 is a graph showing the weighting factors of a triangle filter.

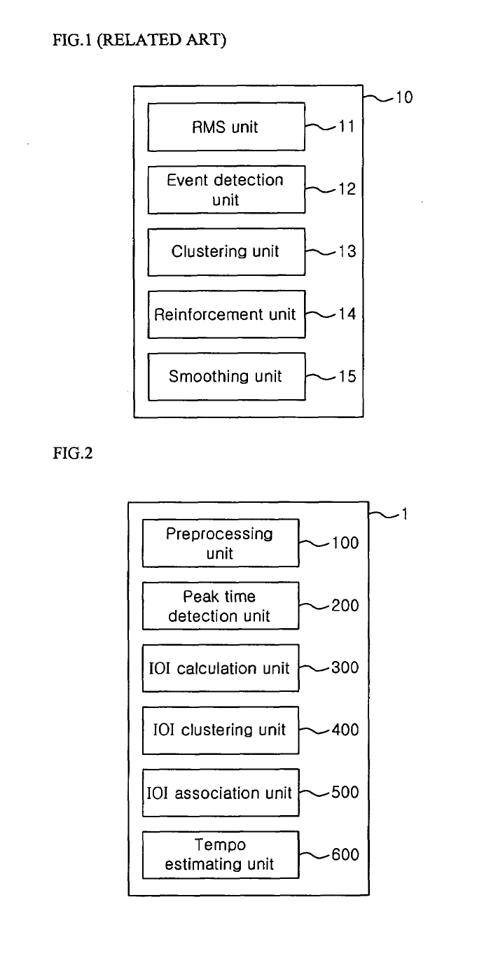

### DETAILED DESCRIPTION OF THE PREFERRED EMBODIMENTS

Hereinafter, preferred embodiments of the present invention will be described in detail with reference to the accompanying drawings.

First, the audio data of the illustrated embodiments are discrete audio data, into which the analog audio data, for example, have been sampled at a predetermined sampling rate.

FIG. 2 is a block diagram of a tempo estimating apparatus according to an embodiment of the present invention.

Referring to FIG. 2, the tempo estimating apparatus 1 according to an embodiment of the present invention comprises a preprocessing unit 100, a peak time detection unit 200, an inter-onset interval (IOI) calculation unit 300, an IOI clustering unit 400, an IOI association unit 500, and a tempo estimating unit 600.

The preprocessing unit 100 receives the audio data, preprocesses the received audio data, and outputs the audio data suitable for peak time detection of the audio data through a predetermined number of channels.

More specifically, the preprocessing unit 100 receives the audio data which have been sampled at a predetermined sampling rate R. The preprocessing unit 100 divides the received audio data into frames with a predetermined length w, e.g., frames with a length of 20 milliseconds. The preprocessing unit 100 performs discrete Fourier transform (DFT), e.g., fast Fourier transform (FFT), on each frame and creates the audio data in the frequency domain, i.e., Fourier coefficients, for each frame.

Next, the preprocessing unit 100 performs the filtering and linear regression operations on each frame. First, the preprocessing unit 100 outputs the first audio data A[k, 1], A[k,2], . . . , A[k,l], . . . , and A[k,L], which have been filtered through L triangle band-pass filters having with different pass bands from one another. Next, the preprocessing unit 100 performs a linear regression on the filtered audio data and outputs the second audio data S[k,1], S[k,2], . . . , S[k,l], . . . , and S[k,L]. Here, k is a frame index, and l is a channel number, i.e., a filter number or linear regression module number.

That is, each of the frames contains the w×R audio data samples, and one first and one second audio data are created for one frame by the filtering and linear regression operations of the preprocessing unit 100. Detailed descriptions on the preprocessing unit 100 will be discussed shortly.

The peak time detection unit 200 individually receives the preprocessed first and second audio data through the respective channels of the preprocessing unit 100. The peak time detection unit 200 detects the peak time, at which the amplitude of the second audio data reaches a peak value, from the second audio data within a peak time detection interval M, e.g., 5 seconds, by the respective channels.

The peak time detection operation of the peak time detection unit 200 can be expressed as the following mathematical expression (1).

$${P}_{l} [ a ] = {arg max}_{i} ( S [ i , l ] ) \\ from i = {P}_{l} [ a - 1 ] + d to i = {P}_{l} [ a - 1 ] + 3 d , \\ A [ {P}_{l} [ a ] , l ] > {T}_{1} , S [ {P}_{l} [ a ] , l ] > {T}_{2} , \\ {P}_{l} [ 0 ] = k - \frac{M}{w} - d , {P}_{l} \leq k , \qquad ( 1 )$$

wherein pᵢ[] is a frame index of the second audio data having a peak value, i.e., a detected peak time, a is a peak time index, i is a frame index of the first and second audio data used for detecting the peak time, l is a channel number, 2d is the size of a peak time detection window, A[] is the amplitude of the first audio data, S[] is the amplitude of the second audio data, T₁ is a first boundary value of A[], T₂ is a second boundary value of S[], k is a current frame index for which a tempo is to be estimated, M is a peak time detection interval, R is a sampling rate, and w is the time length of frame.

More specifically, if the peak time detection unit 200 initially receives the first audio data A[k,1] and the second audio data S[k,1] from the l^{th} channel of the preprocessing unit 100, it performs peak time detection on the second audio data within a previous peak time detection interval M from the current frame index k of the first and second audio data.

That is, the peak time detection unit performs the peak time detection for a peak time detection interval containing M/w audio data samples, e.g., 5 seconds/20 milliseconds=250 samples. To this end, it detects frame indexes of the second audio data having a local peak value from the second audio data lying between a point of d frame index after Pₗ[0], i.e., k−M/w−d, and a point of 3d frame indexes after Pₗ[0]. That is, 2d becomes the size of a peak time detection window for detecting the peak time. If the amplitude of the first or second audio data at a certain peak time among the detected peaks is smaller than a predetermined first or second boundary value, the relevant peak is discarded. The reason is that the peak value at the discarded peak time is a peak value of the noise data or is unlikely to be a peak value representing a tempo. As the boundary values are set larger, an amount of operations needed in estimating a tempo of the input audio data will be reduced.

If the peak time detection unit 200 does not detect a peak time within the peak time detection window, it increases d by 2d and performs the peak time detection operation again.

On the other hand, if the peak time detection unit 200 detects the peak time within the peak time detection window, it performs the peak time detection operation again from the lastly detected peak time Pₗ[a−1].

If the peak time detection operation is performed through all the peak time detection intervals M, i.e., all the detection operations have been completed up to the second audio data S[k,l] corresponding to the input k^{th} frame, the peak time detection unit 200 outputs all the peak times Pₗ[1], Pₗ[2], . . . , and Pₗ[P] detected against the second audio data of the th channel to the 101 calculation unit 300. Here, P is the total number of detected peak times.

The IOI calculation unit 300 individually receives the detected peak times through the respective channels of the peak time detection unit 200 and calculates inter-onset intervals (IOIs) between the detected peak times of each channel.

The IOI calculating operation of the IOI calculation unit 300 can be expressed as the following mathematical expression (2).

IOIₗ[k,2a−1]=Pₗ[a+1]−Pₗ[a]

IOIₗ[k,2a]=pₗ[a+2]−Pₗ[a] (2)

a=1,2,3, . . . ,P−2,

wherein IOIₗ[] is a calculated IOI, Pₗ[] is a detected peak time, k is a current frame index, a is a peak time index, P is the total number of detected peak times, and l is a channel number.

More specifically, if the IOI calculation unit 300 receives the detected peak times, e.g., Pₗ[1], through each channel, it calculates IOIₗ[1] and IOIₗ[2] which correspond to the IOIs between Pₗ[1] and two peak times Pₗ[2] and Pₗ[3] detected after Pₗ[1]. Next, the IOI calculation unit 300 repeats the IOI calculating operation with respect to Pₗ[2], Pₗ[3], . . . , and Pₗ[P−2] to calculate two IOIs for each peak time. The IOI calculation unit 300 individually outputs the calculated IOIs to the IOI clustering unit 400 through each channel.

It is apparent that the IOI calculation unit 300 can employ a variety of methods of calculating the IOIs in addition to the method of calculating the IOIs between a specific peak time and two peak times detected after the specific peak time.

The IOI clustering unit 400 sorts the IOIs in order of size, clusters the sequentially sorted IOIs by IOIs having a predetermined range of size difference, and calculates the number and mean of the IOIs contained in each IOI cluster.

More specifically, the IOI clustering unit 400 individually receives the calculated IOIs through each channel of the IOI calculation unit 300 and merges the IOIs into an IOI pool. The IOI clustering unit 400 calculates the sizes of the IOIs in the IOI pool, i.e., IOI sizes M_IOI[k,0], M_IOI[k,2], . . . , and M_IOI[k,Tm], and the number of the IOIs having the respective IOI sizes, i.e., IOI size counts M_IOI_C[k,0], M_IOI_C[k,2], . . . , and M_IOI_C[k,Tm]. The IOI sizes M_IOI[k,0], M_IOI[k,2], . . . , and M_IOI[k,Tm] are sorted in order of the IOI size.

Here, Tm denotes the total number of the IOI sizes of the IOIs in the IOI pool, M means “merged,” and C means a “count.”

Then, the IOI clustering unit 400 creates the IOI clusters by clustering the sequentially sorted IOI sizes M_IOI[k,0], M_IOI[k,2], . . . , and M_IOI[k,Tm] according to the IOI sizes having a predetermined range of size difference.

Further, using the IOI sizes and the corresponding IOI size counts, the IOI clustering unit 400 calculates the mean of the IOIs CL_IOI[k,0], CL_IOI[k,2], . . . , and CL_IOI[k,Tc] of the respective IOI clusters for the current frame index k, for which a tempo is to be estimated, and the number of the IOIs CL_IOI_C[k,0], CL_IOI_C[k,2], . . . , and CL_{—IOI}_C[k,Tc] contained in the respective IOI clusters, and then outputs them to the IOI association unit 500. Here, Tc+1 is the total number of the IOI clusters.

The operation of the IOI clustering unit 400 for creating the IOI clusters according to the IOI sizes can be implemented in the following pseudo code.

Ref=0;
Tc=0;
CL_IOI[k,0]=M_IOI[k,Ref]*M_IOI_C[k,Ref];
CL_IOI_C[k,0]=M_IOI_C[k,Ref];
for(i=0; i<Tm; i++)
{
if (((M_IOI[k,i]−M_IOI[k,
i−1])<=2)&&((M_IOI[k,i]−M_IOI[k,Ref])<=2))
{
CL_IOI[k,Tc]+=M_IOI[k,i]*M_IOI_C[k,i];
CL_IOI_C[k,Tc]+=M_IOI_C[k,i];
if(M_IOI_C[k,i]>=M_IOI_C[k,Ref]) Ref=i;
}
else
{
Ref=i;
CL_IOI[k,Tc]/=CL_IOI_C[k,Tc];
Tc++;
CL_IOI[k,Tc]=M_IOI[k,i]*M_IOI_C[k,i];
CL_IOI_C[k,Tc]=M_IOI[k,i];
}
}

For each IOI cluster, the 101 association unit 500 detects, among all of the IOI clusters, the IOI clusters each of which the mean IOI is a predetermined multiple of the rational number, e.g., 2, 4, ¾, 5/4 to 7/4, or 9/4 to 11/4, of the mean IOI of a relevant one of the IOI clusters, and determines a cluster weighting factor of each IOI cluster according to the number of the IOIs contained in the relevant IOI cluster and the respective IOI clusters detected in association with the IOIs.

If the audio data input to the tempo estimating apparatus 1 are directed to the music of a 4/4 rhythm, the IOIs have a relation of a multiple of ¼ between one another. That is, if the input audio data are directed to the music of a 4/4 rhythm, the mean IOIs having a relation of a multiple of ¼ between one another, among the mean IOIs of the IOI clusters clustered by the IOI clustering unit 400, are associated with other and highly likely to accurately reflect the tempo of the input audio data. The 101 association unit 500 calculates the cluster weighting factors to reflect such peculiarity of the music audio data. This can be applied to a variety of music including music of a 3/4 rhythm, in which the respective IOIs have a relation of the multiple of ⅓ between one another. Since most of music generally has a 4/4 rhythm, the rational number is preferably set to ¼ when the rhythm of the input music audio data is not known in advance.

The cluster weighting factor calculating operation of the IOI association unit 500 can be expressed as the following mathematical expression (3).

$$w [ k , i ] = 2 CL\_IOI \_C [ k , i ] + {\sum }_{j ∈ multi [ k , i ]} CL\_IOI \_C [ k , j ] + 0.5 {\sum }_{j ∈ quarter [ k , i ]} CL\_IOI \_C [ k , j ] \\ multi [ k , j ] = \{ \begin{matrix}j \vert d 2 ( 0.25 CL\_IOI \_C [ k , i ] \cdot CL\_IOI \_C [ k , j ] ) < 0.05 \\ and round ( f ( 0.25 CL\_IOI \_C [ k , j ] , CL\_IOI \_C [ k , j ] ) ) = 2 \\ or round ( f ( 0.25 CL\_IOI \_C [ k , j ] , CL\_IOI \_C [ k , j ] ) ) = 4\end{matrix} \} \\ quarter [ k , j ] = \{ \begin{matrix}j \vert d 2 ( 0.25 CL\_IOI \_C [ k , i ] \cdot CL\_IOI \_C [ k , j ] ) < 0.05 \\ and round ( f ( 0.25 CL\_IOI \_C [ k , j ] , CL\_IOI \_C [ k , j ] ) ) = 3 \\ or 5 \leq round ( f ( 0.25 CL\_IOI \_C [ k , j ] , CL\_IOI \_C [ k , j ] ) ) \leq 7 \\ or 9 \leq round ( f ( 0.25 CL\_IOI \_C [ k , j ] , CL\_IOI \_C [ k , j ] ) ) \leq 11\end{matrix} \} \\ 1 \leq i \leq Tc \\ f ( x , y ) = y / x , \\ d 1 ( x , y ) = \vert y - round ( f ( x , y ) + 0.5 ) x \vert , \\ d 2 ( x , y ) = \{ \begin{matrix}1 - d 1 ( x , y ) / y & if & d 1 ( x , y ) / y < 0.5 \\ d 1 ( x , y ) / y & if & d 1 ( x , y ) / y \geq 0.5\end{matrix} , \qquad ( 3 )$$

where w[] is a cluster weighting factor of an IOI cluster, CL_IOI_C[] is the number of IOIs contained in an IOI cluster, k is a current frame index, i is an IOI cluster index, multi[] is an IOI cluster index of an IOI cluster whose mean IOI is an integral multiple of the mean IOI of an IOI cluster CL_IOI[k,i], quarter[] is an IOI cluster index of an IOI cluster whose mean IOI is a multiple of ¾, 5/4 to 7/4, or 9/4 to 11/4 of the mean IOI of an IOI cluster CL_IOI[k,i], and Tc is the total number of IOI cluster indexes.

Further, round( ) is a round down function, d1(x,y) is a first distance function, and d2(x,y) is a second distance function. d1(x,y) represents a distance between y and a multiple of x closest to y, and d2(x,y) is a distance of d1(x,y) normalized against y.

More specifically, the IOI association unit 500 receives the mean IOIs CL_IOI[k,0], CL_IOI[k,2], . . . , and CL_IOI[k,Tc] of the respective IOI clusters and the numbers of IOIs CL_IOI_C[k,0], CL_IOI_C[k,2], . . . , and CL_IOI_C[k,Tc] contained in the respective IOI clusters from the IOI clustering unit 400.

For each IOI cluster, the 101 association unit 500 detects, among all of the IOI clusters, the IOI clusters each of which the mean IOI (e.g., CL_IOI[k,2] to CL_IOI[k,Tc]) is a predetermined multiple of the rational number, e.g., 2, 4, ¾, 5/4 to 7/4, or 9/4 to 11/4, of the mean IOI of a relevant one of the IOI clusters, e.g., CL_IOI[k,0].

In the mathematical expression (3), although the mean IOI of an IOI cluster does not exactly become a multiple of the predetermined rational number, the IOI cluster will be detected using the functions d1( ), d2( ), and round( ) if the mean IOI is within a predetermined range, e.g., if d2 is less than 0.05. This is to provide a certain tolerance considering the effects arising from noises or the like contained in audio data. That is, in the illustrated embodiment, the multiple of a rational number means a multiple of a rational number or a numeral within a predetermined distance from the multiple of a rational number.

Further, in the mathematical expression (3), if the mean IOI is greater than a predetermined multiple of a relevant mean IOI, i.e., a multiple of four, the relevant IOI cluster is not detected although the mean IOI is the multiple of a rational number. The reason is that if the size difference between mean IOIs is large, it is highly likely that there is no correlation between the two data.

Then, the IOI association unit 500 determines cluster weighting factors w[k,1], w[k,2], . . . , and w[k,Tc] of the respective IOI clusters according to the number of IOIs CL_IOI_C[k,] contained in each IOI cluster and the IOI clusters detected in connection with the IOIs and outputs the weighting factors to the tempo estimating unit 600.

In the mathematical expression (3), a calculation weighting factor is set to 2 if the number of IOIs is correlated with the relevant IOI cluster, set to 1 if the mean IOI of an IOI cluster is a multiple of an integer, i.e., 2 or 4, of the mean IOI of the relevant IOI cluster, and set to 0.5 if the mean IOI of an IOI cluster is a multiple of ¾, 5/4 to 7/4, or 9/4 to 11/4 of the mean IOI of the relevant IOI cluster, and the cluster weighting factors have been then calculated. However, the calculation weighting factor can be changed according to the situations to which the present invention is applied.

The tempo estimating unit 600 determines genre weighting factors for the respective IOI clusters according to the predetermined genre data and estimates any one of the mean IOIs as a tempo of the input audio data according to the cluster weighting factors w[k,1], w[k,2], . . . , and w[k,Tc] and the determined genre weighting factors.

The tempo estimating operation of the tempo estimating unit 600 can be expressed as the following mathematical expression (4).

B_{—}IOI[k]=CL_{—}IOI[k,^{arg}ᵢ^{max}(w[k,i]·g_{—}w[g,CL_{—}IOI[k,i]])] (4)

1≦i≦T_{c},

wherein B_IOI[] is an estimated tempo, k is a current frame index, CL_IOI[] is a mean IOI of an IOI cluster, i is an IOI cluster index, w[] is a cluster weighting factor of an IOI cluster, g_w[] is a genre weighting factor, g is genre data, and Tc is the total number of IOI clusters.

More specifically, according to the predetermined genre data, the tempo estimating unit 600 calculates a genre weighting factor for the mean IOI of each IOI cluster based on a predetermined reference table.

If a music genre related to the audio data input in the tempo estimating apparatus 1 is previously known, a high genre weighting factor is given to the mean IOI closer to a tempo, which frequently appears in the relevant genre, in order to more accurately perform the tempo estimation. For example, if the input audio data are directed to a dance genre, the higher genre weighting factor will be assigned to the smaller mean IOI.

The tempo estimating unit 600 estimates any one of the mean IOIs as a tempo of the input audio data according to the genre and cluster weighting factors.

In the mathematical expression (4), an optimal IOI cluster index obtained when a product of the genre weighting factor and the cluster weighting factor will be maximum is calculated, and the mean IOI of an IOI cluster corresponding to the optimal IOI cluster index is estimated as a tempo of the frame having the frame index k.

The tempo estimating apparatus 1 estimates a tempo of input audio data every frame, e.g., at 20 milliseconds, in the aforementioned method using the audio data preprocessed for a previous peak time detection interval, e.g., 5 seconds, from a relevant frame.

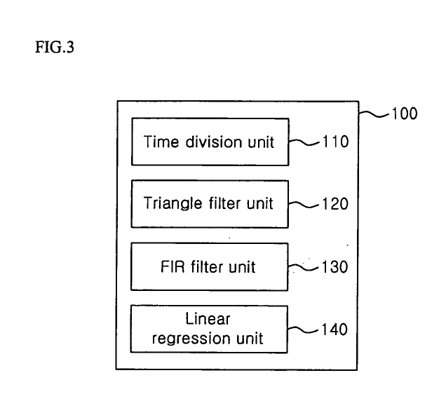

FIG. 3 is a detailed block diagram of the preprocessing unit 100 of FIG. 2 according to an embodiment of the present invention.

Referring to FIG. 3, the preprocessing unit 100 of FIG. 2 according to an embodiment of the present invention comprises a time division unit 110, a triangle filter unit 120, a finite impulse response (FIR) filter unit 130, and a linear regression unit 140.

The time division unit 110 receives the audio data sampled at a predetermined sampling rate R and divides the received audio data into frames with a predetermined length w, e.g., frames with a length of 20 milliseconds. Then, the time division unit 110 performs the discrete Fourier transform (DFT), e.g., fast Fourier transform (FFT), on each frame and creates audio data in the frequency domain, i.e., Fourier coefficients, for each frame, and finally outputs the audio data in the frequency domain to the triangle filter unit 120.

The triangle filter unit 120 comprises a plurality of triangle filters for performing the band pass filtering operation on the Fourier coefficients according to the predetermined frequency bands and outputting band pass filtered frame audio data to the peak time detection unit. The predetermined bands of the respective triangle filters have uniform bandwidth on a Mel frequency domain.

The band pass filtering operation of the triangle filters included in the triangle filter unit 120 can be expressed as the following mathematical expression (5).

$$T [ k , l ] = {\sum }_{j = 0}^{N / 2} {weight}_{1} ( j ) mag ( k , j ) \\ 1 \leq l \leq L , \qquad ( 5 )$$

wherein t[] is the filtered frame audio data, k is a current frame index, N is DFT length, weightₗ(j) is a weighting factor for the j^{th} Fourier coefficient size of the l^{th} triangle filter, mag(j) is the size of the j^{th} Fourier coefficient of the k^{th} frame, l is a triangle filter number, i.e., a channel number, and L is the total number of triangle filters, i.e., total number of channels.

More specifically, the triangle filter unit 120 receives the audio data in the frequency domain, i.e., Fourier coefficients, of the frame and performs the band pass filtering operation on the received Fourier coefficients through L triangle filters, e.g., five triangle filters. Then, the triangle filter unit 120 creates the frame audio data representative of the frame and individually outputs the frame audio data to the FIR filter unit 130 through L channels corresponding to the L triangle filters.

In the mathematical expression (5), the triangle filter creates the band pass filtered frame audio data by summing up the respective Fourier coefficients multiplied by the predetermined weighting factors. In another embodiment, instead of the Fourier coefficients, a variety of values such as squares of Fourier coefficients may be utilized.

As shown in FIG. 13, the triangle filters have uniform bandwidths different from one another on a Mel frequency domain. FIG. 13 shows the weighting factors of the respective triangle filters when five triangle filters having uniform bandwidth on the Mel frequency domain are applied to audio data with a maximum frequency of 4000 Hz.

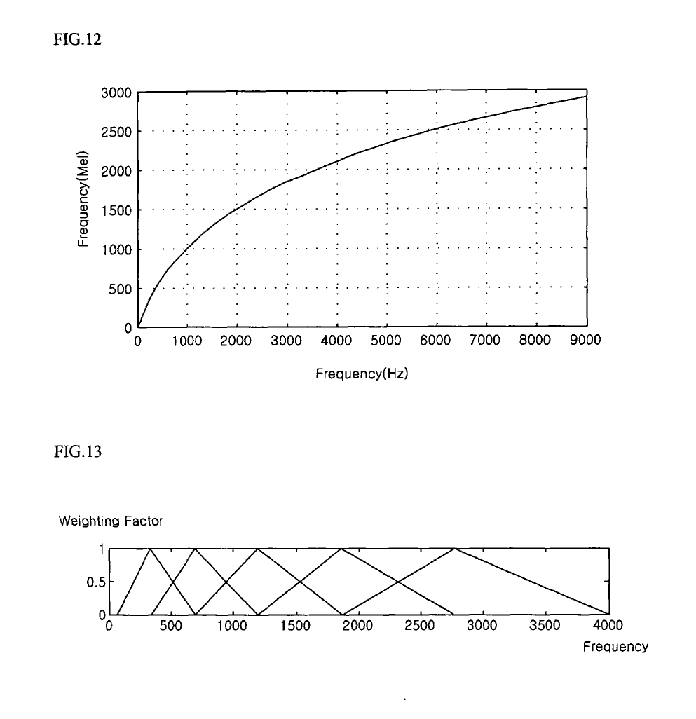

The Mel frequency is widely used in the field of speech recognition since the human hearing characteristics are well reflected. The relation between linear frequency and Mel frequency is shown in FIG. 12 and can also be expressed as the following mathematical expression (6).

Mel(f)=2595log₁₀(1+(f/700)), (6)

wherein Mel(f) is a Mel frequency and f is a linear frequency.

Audio data may contain human voice data together with musical accompaniment data with a certain tempo. Voice energy of a human being is generally concentrated in a specific frequency band, e.g., 0 to 7 kHz. The tempo estimating apparatus 1 obtains the audio data in each frequency band and performs peak detection and IOI calculation operations in each frequency band. Therefore, the tempo estimation of the entire audio data is less influenced by audio data existing within a specific frequency band. Further, even when the audio data contain data, such as human voice data, which are distributed mainly in a specific frequency band and hinder the tempo estimation, the tempo estimation can be effectively performed.

The FIR filter unit 130 comprises L FIR filters for individually performing the low pass filtering operation on the frame audio data input through the L channels to eliminate the noise contained in the input frame audio data and outputting the noise-free first audio data to the linear regression unit.

The low pass filtering operation of the FIR filter included in the FIR filter unit 130 can be expressed as the following mathematical expression (7).

$$A [ k , l ] = {\sum }_{j = 0}^{J} FIR [ j ] T [ k - j , l ] , \qquad ( 7 )$$

wherein A[] is low pass filtered first audio data, k is a current frame index, l is a FIR filter number, i.e., a channel number, FIR[] is a FIR filter coefficient, T[] is frame audio data, and J is an order FIR filter.

More specifically, the l^{th} FIR filter of the FIR filter unit 130 performs the low pass filtering operation on the k^{th} frame using the (k−j)^{th} frame to k^{th} frame as shown in the mathematical expression (7) and outputs the noise-free first audio data A[k,l] through the l^{th} channel.

The linear regression unit 140 performs a linear regression operation on the input first audio data to smooth the input first audio data and creates the second audio data, i.e., slope data of the input first audio data.

The linear regression operation of the linear regression unit 140 can be expressed as the following mathematical expression (8).

$$S [ k , l ] = \frac{4 {\sum }_{i = k - m + 1}^{k} \frac{iwA [ i , l ]}{R} ( {\sum }_{i = k - m + 1}^{k} A [ i , l ] ) ( {\sum }_{i = k - m + 1}^{k} \frac{iw}{R} )}{4 ( {\sum }_{i = k - m + 1}^{k} {A [ i , l ]}^{2} ) - {( {\sum }_{i = k - m + 1}^{k} A [ i , l ] )}^{2}} , \qquad ( 8 )$$

wherein S[]is second audio data, k is a current frame index, l is a linear regression module number, i.e., a channel number, m is a regression window size, w is a time length of a frame, and R is a sampling rate.

More specifically, the linear regression unit 140 receives the first audio data through the respective channels of the FIR filter unit 130 to perform the linear regression on the first audio data, and outputs the second audio data S[k,l] to S[k,L] through the respective channels.

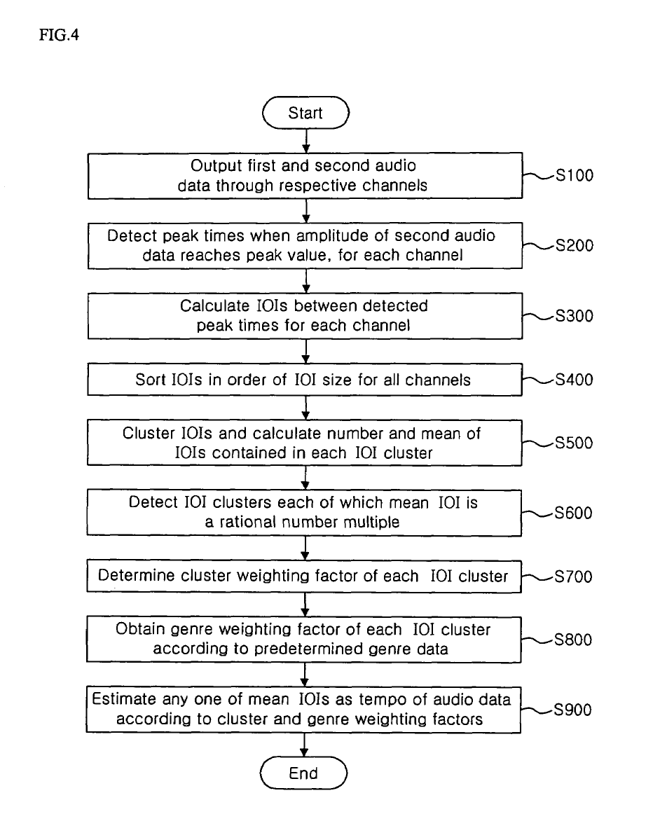

FIG. 4 is a flowchart illustrating a method of estimating a tempo according to an embodiment of the present invention.

Referring to FIG. 4, the first and second audio data suitable for detecting peak times of the audio data are output through a predetermined number of channels (step S100). The preprocessing unit 100 of the tempo estimating apparatus 1 according to an embodiment of the present invention receives audio data, preprocesses the input audio data, and outputs the first and second audio data suitable for detecting peak times of the audio data through a predetermined number of channels.

A step of detecting peak times when the amplitude of the second audio data reaches a peak value is performed for each channel (step S200). The peak time detection unit 200 of the tempo estimating apparatus 1 individually receives the preprocessed first and second audio data through the respective channels of the preprocessing unit 100 and detects peak times when the amplitude of the second audio data reaches a peak value among the second audio data falling within a peak time detection interval M, e.g., 5 seconds, for each channel.

Next, the IOI calculation unit 300 of the tempo estimating apparatus 1 individually receives the detected peak times through the respective channels of the peak time detection unit 200 and calculates IOIs between the peak times detected for each channel (step S300).

Then, the IOI clustering unit 400 of the tempo estimating apparatus 1 collects the peak times detected for each channel and sorts the IOIs in order of their size (step S400).

Next, the IOI clustering unit 400 of the tempo estimating apparatus 1 clusters the sequentially sorted IOIs by IOIs with a predetermined range of size difference and calculates the number and mean of the IOIs contained in each IOI cluster (step S500).

Then, the IOI association unit 500 of the tempo estimating apparatus 1 detects IOI clusters, each of which mean IOI is a predetermined rational number multiple, among the IOI clusters (step S600).

A step of determining a cluster weighting factor for each IOI cluster is performed (step S700). For each IOI cluster, the IOI association unit 500 detects, among all of the 101 clusters, the IOI clusters each of which the mean IOI is a multiple of a predetermined rational number, e.g., 2, 4, ¾, 5/4 to 7/4, or 9/4 to 11/4, of the mean IOI of a relevant one of the IOI clusters, and determines a cluster weighting factor of the IOI cluster according to the number of IOIs contained in the relevant IOI cluster and the IOI clusters detected in association with the IOIs.

Then, the tempo estimating unit 600 of the tempo estimating apparatus 1 calculates a genre weighting factor for each IOI cluster according to predetermined genre data (step S800).

Then, the tempo estimating unit 600 estimates any one of the mean IOIs as a tempo of the audio data according to the cluster and genre weighting factors (step S900) and terminates the process.

Detailed operations of the aforementioned steps have been described in detail in the descriptions in connection with FIGS. 2 and 3.

FIG. 5 is a flowchart illustrating a method of preprocessing audio data according to an embodiment of the present invention.

Referring to FIG. 5, the time division unit 110 of the tempo estimating apparatus 1 receives the audio data sampled at a predetermined sampling rate R and divides the received audio data into frames with a predetermined length w, e.g., frames with a length of 20 milliseconds (step S110).

Then, the time division unit 110 performs DFT, e.g., FFT, on each frame and creates the audio data in the frequency domain, i.e., Fourier coefficients, for each frame (step S112).

Then, the triangle filter unit 120 of the tempo estimating apparatus 1 receives Fourier coefficients of the frame and performs the band pass filtering operation on the received Fourier coefficients through L triangle filters, e.g., five triangle filters. The band pass filtered L frame audio data are output individually through L channels corresponding to the L triangle filters (step S114). The predetermined bands of the respective triangle filters have uniform bandwidth on a Mel frequency domain.

Then, the FIR filter unit 130 of the tempo estimating apparatus 1 individually performs the low pass filtering operation on the frame audio data input through the L channels to eliminate noise contained in the input frame audio data and outputs the noise-free first audio data to the linear regression unit (step S116).

Then, the linear regression unit 140 of the tempo estimating apparatus 1 performs the linear regression operation on the input first audio data to smooth the input first audio data, creates second audio data, i.e., slope data of the input first audio data (step S118). Finally, the process is terminated.

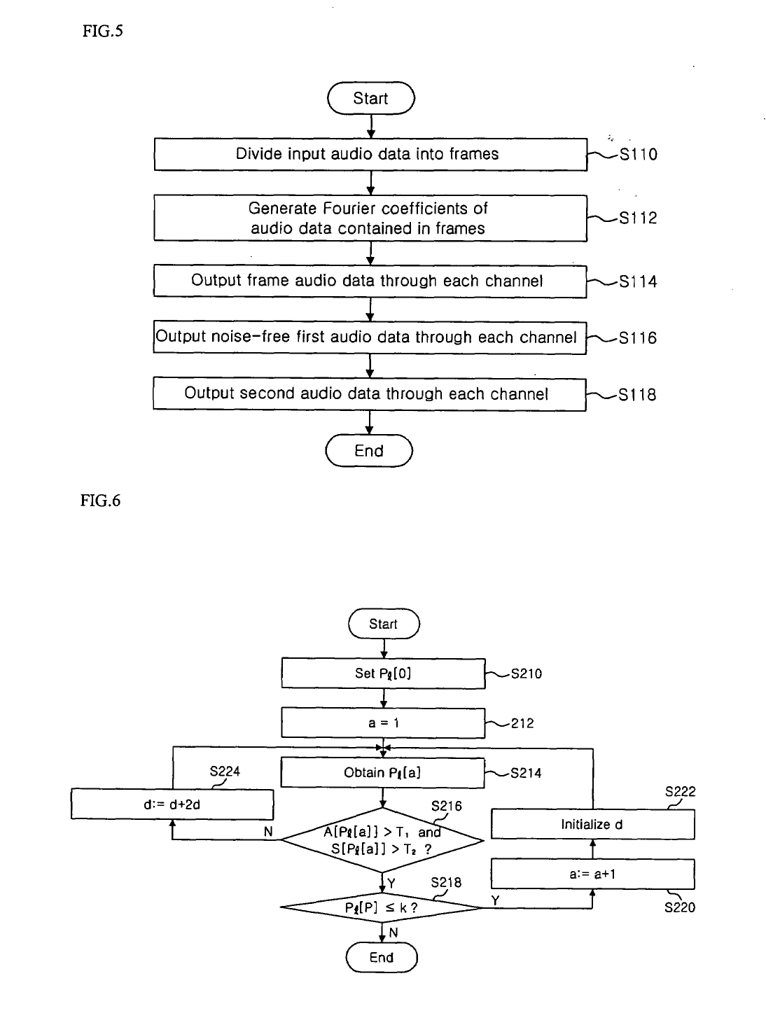

FIG. 6 is a flowchart illustrating a method of detecting peak times according to an embodiment of the present invention.

Referring to FIG. 6, the peak time detection unit 160 of the tempo estimating apparatus 1 according to an embodiment of the present invention sets Pₗ[0] corresponding to a detection reference frame index to k−M/w−d (step S210). Here, k is a current frame index, M is a peak detection interval, w is a time length of a frame, and 2d is the size of a peak time detection window.

Then, the peak time detection unit 160 sets a peak time index a to 1 (step S212).

Then, the peak time detection unit 160 obtains a peak time Pₗ[a] (step S214). The peak time Pₗ[a] is obtained by detecting the frame index of S[k,l] having a local peak value among second audio data S[k,l] corresponding to frame indexes Pₗ[a−1]+d to Pₗ[a−1]+3d.

Then, the peak time detection unit 160 determines whether first audio data A[Pₗ[a]] is greater than a first boundary value T₁ and second audio data S[Pₗ[a]] is greater than a second boundary value T₂ (step S216).

If it is determined in step S216 that the first audio data A[Pₗ[a]] is greater than a first boundary value T₁ and the second audio data S[Pₗ[a]] is greater than a second boundary value T₂, the peak time detection unit 160 determines whether the peak time Pₗ[a] is less than or equal to the current frame index k (step S218).

If it is determined in step S218 that the peak time Pₗ[a] is greater than the current frame index k, the process is terminated.

On the other hand, if it is determined in step S218 that the peak time Pₗ[a] is less than or equal to the current frame index k, the peak time detection unit 160 sets the peak time index a to a value of the peak time index a added by 1 (step S220).

Then, the peak time detection unit 160 initializes d, which is a half size of the peak time detection window, to an initial value of d (step S222) and proceeds to step S214.

On the other hand, if it is determined in step S216 that the first audio data A[Pₗ[a]] is not greater than a first boundary value T₁ or second audio data S[Pₗ[a]] is not greater than a second boundary value T₂, the peak time detection unit 160 sets d to a value of d added by 2d (step S224) and proceeds to step S214.

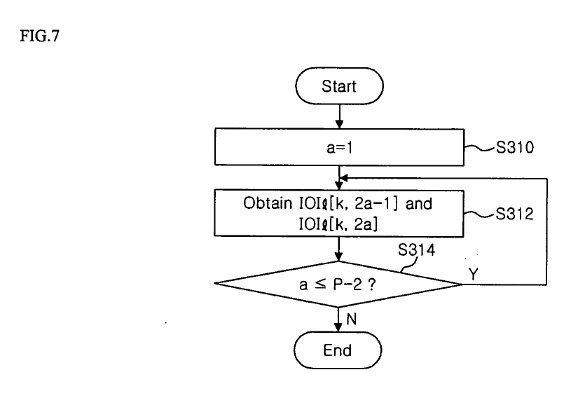

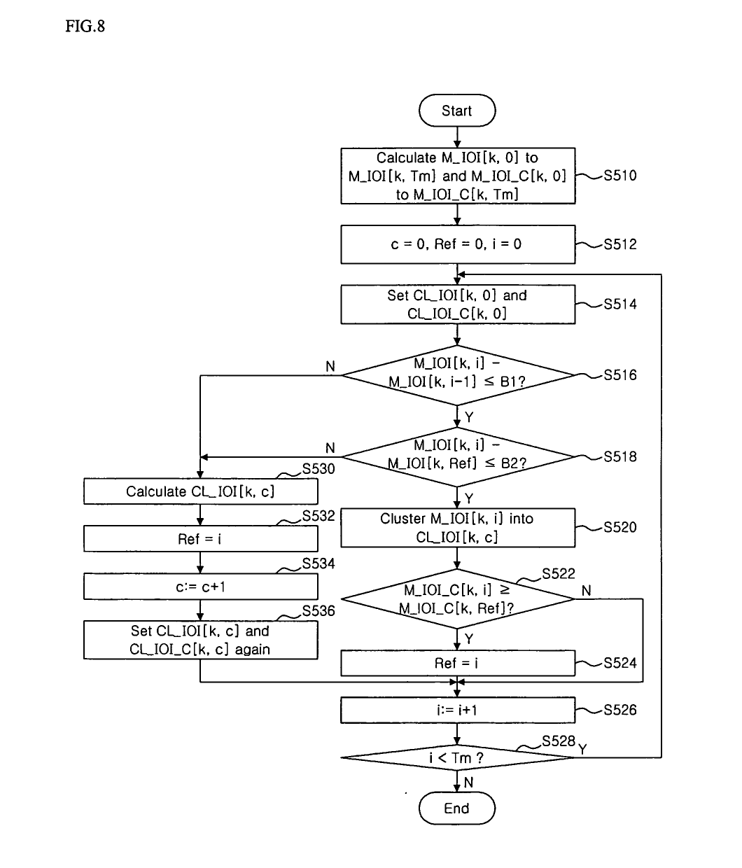

FIG. 7 is a flowchart illustrating an IOI calculating method according to an embodiment of the present invention.

Referring to FIG. 7, the IOI calculation unit 300 of the tempo estimating apparatus 1 according to an embodiment of the present invention sets the peak time index a to 1 (step S310).

Then, the IOI calculation unit 300 calculates IOIs IOIₗ[k,2a−1] and IOIₗ[k,2a] (step S312). Here, l is a channel number and k is a current frame index.

Then, the IOI calculation unit 300 determines whether the peak time index a is less than or equal to P−2 (step S314). Here, P is the total number of peak times detected for the l^{th} channel.

If it is determined in step S314 that the peak time index a is less than or equal to P−2, the IOI calculation unit 300 proceeds to step S312.

On the other hand, if it is determined in step S314 that the peak time index a is greater than P−2, the process is terminated.

FIG. 8 is a flowchart illustrating an IOI clustering method according to an embodiment of the present invention

Referring to FIG. 8, the IOI clustering unit 400 of the tempo estimating apparatus 1 according to an embodiment of the present invention calculates IOI sizes M_IOI[k,0] to M_IOI[k,Tm] and the number of IOIs with the respective IOI sizes, i.e., IOI size counts M_IOI_C[k,0] to M_IOI_C[k,Tm] (step S510). The IOI sizes M_IOI[k,0] to M_IOI[k,Tm] are sorted, i.e., indexed, in order of size. Here, Tm is the total number of the IOI sizes.

Then, the IOI clustering unit 400 sets the number of IOI clusters c, a cluster reference index Ref, and an IOI size index i to 0 (step S512).

Then, the IOI clustering unit 400 sets the mean IOI CL_IOI[k,0] of an IOI cluster and the number of IOIs CL_IOI_C[k,0] contained in the IOI cluster (step S514). Here, k is a current frame index.

That is, the IOI clustering unit 400 sets the mean IOI CL_IOI[k,0] of the IOI cluster to M_IOI[k,Ref]*M_IOI_C[k,Ref] and the number of IOIs contained in the IOI cluster CL_IOI_C[k,0] to M_IOI_C[k,Ref].

Then, the IOI clustering unit 400 determines whether the difference M_IOI[k,i]−M_IOI[k,i−1] between the i^{th} IOI size and the (i−1)^{th} IOI size is less than or equal to a predetermined range B1, e.g., 2 (step S516).

If it is determined in step S516 that the difference M_IOI[k,i]−M_IOI[k,i−1] between the i^{th} IOI size and the (i−1)^{th} IOI size is less than or equal to a predetermined range B1, e.g., 2, the IOI clustering unit 400 determines whether the difference M_IOI[k,i]−M_IOI[k,Ref] between the i^{th} IOI size and the Ref^{th} IOI size is less than or equal to a predetermined range B2, e.g., 2 (step S518).

If it is determined in step S518 that the difference M_IOI[k,i]−M_IOI[k,Ref] between the i^{th} IOI size and the Ref^{th} IOI size is less than or equal to a predetermined range B2, e.g., 2, the IOI clustering unit 400 clusters the IOI size M_IOI[k,i] into the (c+1)^{th} IOI cluster (step S520).

That is, the IOI clustering unit 400 sets the mean IOI CL_IOI[k,c] of the (c+1)^{th} IOI cluster to a value obtained by adding CL_IOI[k,c] to M_IOI[k,i]*M_IOI_C[k,i] and sets the number of IOIs CL_IOI_C[k,c] contained in the (c+1)^{th} IOI cluster to a value obtained by adding CL_IOI_C[k,c] to M_IOI_C[k,i].

Then, the IOI clustering unit 400 determines whether the i^{th} IOI size M_IOI_C[k,i] is greater than or equal to a reference IOI size M_IOI_C[k,Ref] (step S522).

If it is determined in step S522 that the i^{th} IOI size M_IOI_C[k,i] is greater than or equal to the reference IOI size M_IOI_C[k,Ref], the IOI clustering unit 400 sets the cluster reference index Ref to the IOI index i (step S524).

Then, the IOI clustering unit 400 sets the IOI index i as a value obtained by adding 1 to the IOI index i (step S526).

Then, the IOI clustering unit 400 determines whether the IOI index i is less than the total number of the IOI sizes Tm (step S528).

If it is determined inn step S528 that the IOI index i is less than the total number of the IOI sizes Tm, the IOI clustering unit 400 proceeds to step S514.

On the other hand, if it is determined in step S528 that the IOI index “i” is not less than the total number of the IOI sizes Tm, the process is terminated.

Furthermore, if it is determined in step S522 that the i^{th} IOI size M_IOI_C[k,i] is less than the reference IOI size M_IOI_C[k,Ref], the IOI clustering unit 400 proceeds to step S526.

Furthermore, if it is determined in step S516 that the difference M_IOI[k,i]−M_IOI[k,i−1] between the i^{th} IOI size and the (i−1)^{th} IOI size is greater the predetermined range B1, e.g., 2 or in step S518 that the difference M_IOI[k,i]−M_IOI[k,Ref] between the i^{th} IOI size and the Ref^{th} IOI size is greater than the predetermined range B2, e.g., 2, the IOI clustering unit 400 calculates a mean IOI CL_IOI[k,c] of the (c+1)^{th} IOI cluster (step S530).

That is, the IOI clustering unit 400 sets the mean IOI CL_IOI[k,c] of the (c+1)^{th} IOI cluster to the value of the mean IOI CL_IOI[k,c] divided by the number of IOIs CL_IOI_C[k,c] contained in the (c+1)^{th} IOI cluster.

Then, the IOI clustering unit 400 sets the cluster reference index Ref to the IOI index i (step S532).

Then, the IOI clustering unit 400 sets the IOI cluster index c to the value of the IOI cluster index c added by 1 (step S534).

Then, the IOI clustering unit 400 sets CL_IOI[k,c] and CL_IOI_C[k,c] again (step S536) and proceeds to step S526.

That is, the IOI clustering unit 400 sets the mean IOI CL_IOI[k,c] of the IOI cluster to M_IOI[k,i]*M_IOI_C[k,i] and sets the number of IOIs contained in the IOI cluster CL_IOI_C[k,0] to M_IOI_C[k,i], and proceeds to step S526.

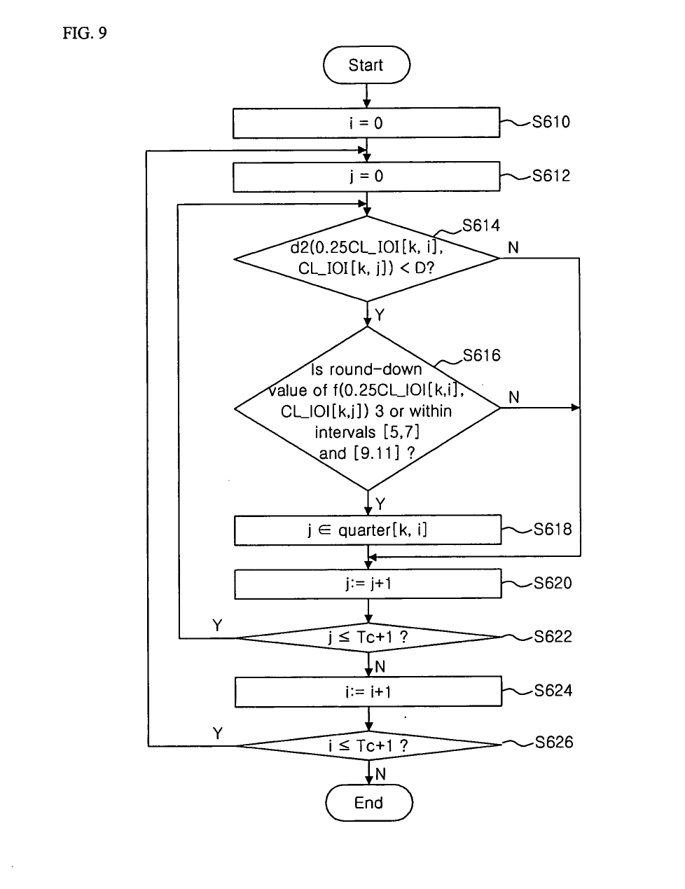

FIG. 9 is a flowchart illustrating a method of detecting associated IOI clusters according to an embodiment of the present invention.

Referring to FIG. 9, the IOI association unit 500 of the tempo estimating apparatus 1 according to an embodiment of the present invention sets the IOI cluster index i to 0 (step S610).

Then, the IOI association unit 500 sets a detection IOI cluster index j to 0 (step S612).

Then, the IOI association unit 500 determines whether a value of the second distance function d2(0.25*CL_IOI[k,i],CL_IOI[k,j]) is less than a predetermined distance D (step S614).

If it is determined in step S614 that a value of the second distance function d2(0.25*CL_IOI[k,i],CL_IOI[k,j]) is less than a predetermined distance D, the IOI association unit 500 determines whether a round-down value of f(0.25*CL_IOI[k,i],CL_IOI[k,j]) belongs to 3, 5 to 7 or 9 to 11 interval (step S616). Here, f(x,y)=y/x.

If it is determined in step S616 that a round-down value of f(0.25*CL_IOI[k,i],CL_IOI[k,j]) belongs to the 3, 5 to 7 or 9 to 11 interval, the IOI association unit 500 includes the detection IOI cluster index j into a ¼ multiple cluster quarter[k,i] (step S618).

Then, the IOI association unit 500 sets the detection IOI cluster index j added by 1 to the detection IOI cluster index j (step S620).

Then, the IOI association unit 500 determines whether the detection IOI cluster index j is less than or equal to the total number of IOI clusters Tc+1 (step S622).

If it is determined in step S622 that the detection IOI cluster index j is greater than the total number of IOI clusters Tc+1, the IOI association unit 500 sets the IOI cluster index i added by 1 to the value of the IOI cluster index i (step S624).

Then, the IOI association unit 500 determines whether the IOI cluster index i is less than or equal to the total number of IOI clusters Tc+1 (step S626).

If it is determined in step S626 that the IOI cluster index i is greater than the total number of IOI clusters Tc+1, the IOI association unit 500 terminates the process.

On the other hand, it is determined in step S622 that the detection IOI cluster index j is less than or equal to the total number of IOI clusters Tc+1, the IOI association unit 500 proceeds to step S614.

Furthermore, if it is determined in step S626 that the IOI cluster index i is less than or equal to total number of IOI clusters Tc+1, the IOI association unit 500 proceeds to step S612.

Furthermore, if it is determined in step S614 that a value of the second distance function d2(0.25*CL_IOI[k,i],CL_IOI[k,j]) is not less than a predetermined distance D or in step S616 that a round-down value of f(0.25*CL_IOI[k,i],CL_IOI[k,j]) does not belong to a 3 or 5 to 7, or 9 to 11 interval, the IOI association unit 500 proceeds to step S620.

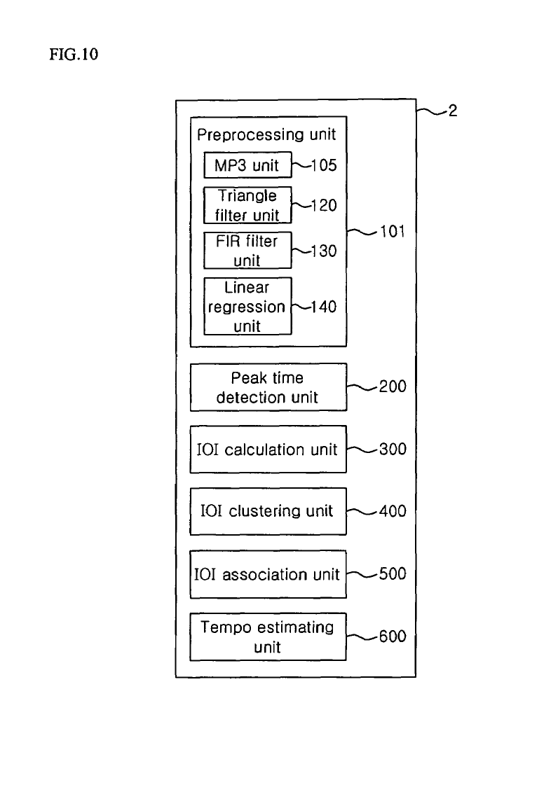

FIG. 10 is a block diagram of a tempo estimating apparatus according to another embodiment of the present invention.

A tempo estimating apparatus according to another embodiment of the present invention is almost the same as the tempo estimating apparatus 1 shown in FIGS. 2 and 3, and thus, only the differences between the two embodiments will be described. Same reference numerals represent the same components throughout the two embodiments of the present invention.

Referring to FIG. 10, the tempo estimating apparatus 2 according to another embodiment of the present invention comprises a preprocessing unit 101, a peak time detection unit 200, an IOI calculation unit 300, an IOI clustering unit 400, an IOI association unit 500, and a tempo estimating unit 600.

The preprocessing unit 101 receives the audio data in the frequency domain, e.g., MPEG audio layer 3 (MP3) data, which are transformed and compressed from audio data in the time domain, and divides the MP3 data into frames with a predetermined length, e.g., the frames with a length of 20 milliseconds. The preprocessing unit 101 preprocesses the MP3 data contained in the frames and outputs audio data suitable for detecting peaks through a predetermined number of channels.

To this end, the preprocessing unit 101 comprises an MP3 unit 105, a triangle filter unit 120, a FIR filter unit 130, and a linear regression unit 140.

The MP3 unit 105 extracts frequency coefficients, e.g., the stereo modified discrete cosine transform (MDCT) coefficients, from the received MP3 data and transforms the extracted stereo MDCT coefficients into mono MDCT coefficients. The MP3 unit 105 outputs the transformed mono MDCT coefficients to the respective triangle filter units 120. The mono MDCT coefficient is a mean value of relevant left and right stereo MDCT coefficients.

MDCT is a transform similar to Fourier transform by which the audio data in the time domain are transformed into audio data in the frequency domain. The MDCT coefficients represent the audio data in the time domain in the form of audio data in the frequency domain.

In order to extract the stereo MDCT coefficients from the MP3 data, the MP3 unit 105 performs Huffman decoding, inverse quantization, rearrangement and the like on the MP3 data. A technique for extracting stereo MDCT coefficients from the MP3 data are well known in the art, and thus, a detailed description thereof will be omitted herein.

The MP3 unit 105 transforms the stereo MDCT coefficients into the mono MDCT coefficients and outputs the mono MDCT coefficients to the triangle filter unit 120.

The triangle filter unit 120 creates the frame audio data using the MDCT coefficients. The subsequent operations are the same as those shown in FIGS. 2 and 3.

MP3 is a compression method for compressing audio data in the time domain into audio data in the frequency domain. When an MP3 player decodes and plays an MP3 file, the audio data in the frequency domain are transformed into the audio data in the time domain.

Before an MP3 decoder transforms the audio data in the frequency domain, i.e., MDCT coefficients, into the audio data in the time domain when playing the MP3 file, the tempo estimating apparatus 2 retrieves the MDCT coefficients and estimates a tempo of audio data contained in the MP3 file.

If the MP3 file is played back in real time, the tempo estimating apparatus 2 can receive MP3 bit streams and estimate the tempo of the audio data contained in the MP3 file in real time. Further, since it is not necessary to additionally transform the audio data in the time domain into the audio data in the frequency domain, the tempo can be more efficiently estimated.

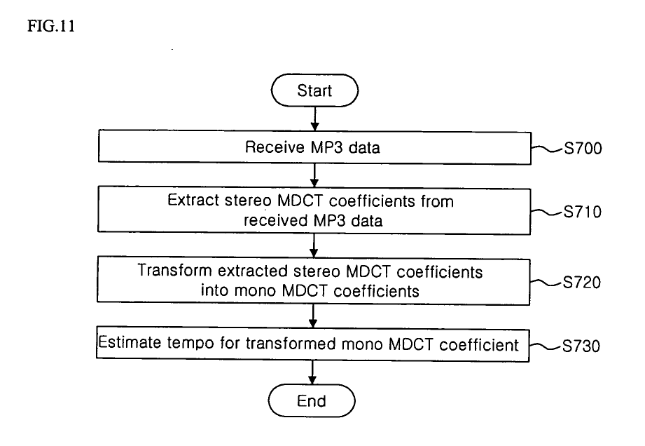

FIG. 11 is a flowchart illustrating a method of estimating a tempo according to another embodiment of the present invention.

Referring to FIG. 11, the MP3 unit 105 of the tempo estimating apparatus 2 according to another embodiment of the present invention receives the audio data in the frequency domain, e.g., MP3 data, into which audio data in the time domain have been transformed and compressed (step S700).

Then, the MP3 unit 105 extracts the frequency coefficients, e.g., stereo MDCT coefficients, from the received MP3 data (step S710).

Then, the MP3 unit 105 transforms the extracted stereo MDCT coefficients into the mono MDCT coefficients and outputs the transformed mono MDCT coefficients to the triangle filter unit 120 of the tempo estimating apparatus 2 (step S720).

Then, the tempo estimating apparatus 2 estimates a tempo for the transformed MDCT coefficients (step S730).

The embodiment shown in FIGS. 10 and 11 is directed to an apparatus and method for estimating a tempo using audio data in the frequency domain into which the audio data in the time domain have been transformed and compressed. The audio data in the frequency domain are not limited to MP3 files, but can be a variety of audio data in the frequency domain.

Although the present invention has been described and illustrated in connection with the specific preferred embodiments, it will be readily understood by those skilled in the art that various modifications and changes can be made thereto without departing from the spirit and scope of the present invention defined by the appended claims.

According to the illustrated embodiments described above, a tempo can be estimated based on the number of IOIs contained in IOI clusters. Thus, there is an advantage in that the tempo can be accurately estimated even for audio data containing noise with high energy.

In addition, a relation of not only an integral multiple but also a rational number multiple between detected IOIs can be reflected when estimating the tempo. Thus, there is another advantage in that the tempo can be accurately estimated even with a smaller number of audio data.

Furthermore, the input audio data are divided into frames with a predetermined length; frequency coefficients contained in each of the divided frames are extracted and a band pass filtering operation is preformed; and peak time detection and IOI calculating operations are then performed according to the frequency bands. Therefore, there is a further advantage in that the tempo estimation can be effectively performed even when the audio data contain data, such as human voice data, which are distributed mainly in specific frequency bands and hinder the tempo estimation.

What is claimed is:

1. An apparatus for estimating a tempo, comprising:
a peak time detection unit for detecting peak times of input audio data when an amplitude of the audio data reaches peak values;
an inter-onset interval (IOI) calculation unit for calculating IOIs between the detected peak times;
an IOI clustering unit for clustering the IOIs according to the respective IOIs with a predetermined range of size difference into a plurality of IOI clusters and for calculating a number of the IOIs and a mean of the IOIs contained in each of the IOI clusters; and
a tempo estimating unit for determining one of the means of the IOIs in the 101 clusters as a tempo of the input audio data according to the number of the IOIs contained in each of the IOI clusters.

2. The apparatus as claimed in claim 1, wherein the IOI calculation unit calculates IOIs between a peak time and a predetermined number of adjacent peak times detected after the peak time.

3. The apparatus as claimed in claim 1, wherein the IOI clustering unit sorts the IOIs in order of size and clusters the sequentially sorted IOIs using the IOIs within a predetermined range of size difference.

4. The apparatus as claimed in claim 1, wherein the tempo estimating unit estimates the mean of the IOIs of one of the IOI clusters having a largest number of the IOIs as the tempo of the input audio data.

5. The apparatus as claimed in claim 1, wherein the tempo estimating unit determines a genre weighting factor for each of the IOI clusters according to predetermined genre data and determines the one of the means of the IOIs in the IOI clusters as the tempo of the input audio data according to the number of the IOIs and the genre weighting factor.

6. The apparatus as claimed in claim 1, further comprising:
an IOI association unit for determining a cluster weighting factor of each of the IOI clusters according to the number of the IOIs contained in the IOI cluster,
wherein among all of the IOI clusters, any one of the IOI clusters whose mean IOI is a predetermined rational number multiple of the mean of the IOIs of a relevant one of the IOI clusters is detected, and the tempo estimating unit determines the one of the means of the IOIs in the IOI clusters as the tempo of the input audio data according to the determined cluster weighting factor.

7. The apparatus as claimed in claim 6, wherein the tempo estimating unit determines a genre weighting factor for each of the IOI clusters according to predetermined genre data and determines the one of the means of the IOIs in the IOI clusters as the tempo of the input audio data according to the cluster weighting factor and the genre weighting factor.

8. The apparatus as claimed in claim 1, further comprising:
a preprocessing unit for dividing the received audio data into frames with a predetermined length, and extracting frequency coefficients contained in each of the frames through discrete Fourier transform to perform a band pass filtering operation if the input audio data are audio data in a time domain or extracting frequency coefficients contained in each of the frames to perform a band pass filtering operation if the input audio data are compressed audio data in a frequency domain.

9. The apparatus as claimed in claim 8, wherein the preprocessing unit further comprises:
a linear regression unit for calculating slope data of the audio data by performing linear regression on the band pass filtered audio data,
wherein the peak time detection unit detects peak times at which the slope data reach the peak values.

10. A method of estimating a tempo, the method comprising:
detecting peak times of input audio data when an amplitude of the audio data reaches peak values;
calculating inter-onset intervals (IOIs) between the detected peak times;
clustering the IOIs according to the respective IOIs within a predetermined range of size difference into a plurality of IOI clusters;
calculating a number the IOIs and a mean of the IOIs contained in each of the IOI clusters; and
determining the one of the means of the IOIs in the IOI clusters as a tempo of the input audio data according to the number of the IOIs contained in each of the IOI clusters.

11. The method as claimed in claim 10, wherein the step of calculating the IOIs comprises the step of calculating the IOIs between a peak time and a predetermined number of adjacent peak times detected after the peak time.

12. The method as claimed in claim 10, wherein the step of clustering comprises the step of sorting the IOIs in order of size and clustering the sequentially sorted IOIs using the IOIs within the predetermined range of size difference.

13. The method as claimed in claim 10, wherein the determining step comprises the step of estimating the mean IOI of one of the IOI clusters having a largest number of the IOIs as the tempo of the input audio data.

14. The method as claimed in claim 10, wherein the estimating step comprises the step of determining a genre weighting factor of each of the IOI clusters according to predetermined genre data and determining the one of the means of the IOIs in the IOI clusters as the tempo of the input audio data according to the number of the IOIs and the genre weighting factor.

15. The method as claimed in claim 10, said method further comprising:
detecting, among all of the IOI clusters, any one of the IOI clusters whose mean IOI is a predetermined rational number multiple of the mean of the IOIs of a relevant one of the IOI clusters; and
determining a cluster weighting factor for each of the IOI clusters according to the number of the IOIs contained in the corresponding IOI cluster and the IOI clusters detected as the rational number multiple, wherein the determining step comprises the step of determining the one of the means of the IOIs in the IOI clusters as the tempo of the input audio data according to the determined cluster weighting factor.

16. The method as claimed in claim 15, wherein the determining step comprises the step of determining a genre weighting factor of each of the IOI cluster according to predetermined genre data and determining the one of the means of the IOIs in the IOI clusters as the tempo of the input audio data according to the cluster weighting factor and the genre weighting factor.

17. The method as claimed in claim 10, said method further comprising:
preprocessing to divide the received audio data into frames with a predetermined length, and to extract frequency coefficients contained in each of the frames through discrete Fourier transform to perform a band pass filtering operation if the input audio data are audio data in a time domain or to extract frequency coefficients contained in each of the frames to perform a band pass filtering operation if the input audio data are compressed audio data in a frequency domain.

18. The method as claimed in claim 17, wherein the step of preprocessing further comprises:
calculating slope data of the audio data by performing linear regression on the band pass filtered audio data,
wherein the peak time detecting step comprises the step of detecting the peak times at which the slope data reach the peak values.

19. An apparatus for estimating a tempo, comprising:
a peak time detection unit for detecting peak times of input audio data when an amplitude of the audio data reaches peak values;
an inter-onset interval (IOI) determining unit for determining IOIs between the detected peak times;
an IOI clustering unit for clustering the IOIs into a plurality of IOI clusters and for determining an average of the IOIs contained in each of the IOI clusters;
a tempo estimating unit for estimating a tempo of the input audio data based on the average of the IOIs of one of the IOI clusters.

20. The apparatus of claim 19, wherein the IOI clustering unit clusters the IOIs based on a predetermined range of size difference of the IOIs.

21. The apparatus of claim 19, wherein the IOI clustering unit determines a number of the IOIs contained in each of the IOI clusters, and the a tempo estimating unit estimates the tempo of the input audio data based on the number of the IOIs contained in each of the IOI clusters.

22. The apparatus of claim 21, wherein the tempo estimating unit estimates the tempo of the input audio data as the average of the IOIs of one of the IOI clusters with a largest number of the IOIs.

23. The apparatus of claim 20, further comprising:
an IOI association unit for determining a cluster weighting factor of each of the IOI clusters based on the number of the IOIs contained in the corresponding IOI cluster, wherein, among all of the IOI clusters, any one of the IOI clusters whose average IOI is a predetermined rational number multiple of the average of the IOIs of a relevant one of the IOI clusters is detected, and the tempo estimating unit determines the average of the IOIs in the one of the IOI clusters as the tempo of the input audio data based on the determined cluster weighting factor.
